(19) United States
(12) Patent Application Publication
(10) Pub. No.: US 2024/0135618 A1
(43) Pub. Date: Apr. 25, 2024

(54) GENERATING ARTIFICIAL AGENTS FOR REALISTIC MOTION SIMULATION USING BROADCAST VIDEOS

(71) Applicant: NVIDIA Corporation, Santa Clara, CA (US)

(72) Inventors: Haotian Zhang, Stanford, CA (US); Ye Yuan, Santa Clara, CA (US); Jason Peng, Vancouver (CA); Viktor Makoviichuk, Santa Clara, CA (US); Sanja Fidler, Toronto (CA)

(73) Assignee: NVIDIA Corporation, Santa Clara, CA (US)

(21) Appl. No.: 18/322,319

(22) Filed: May 23, 2023

Related U.S. Application Data
(60) Provisional application No. 63/414,484, filed on Oct. 8, 2022.

(51) Int. Cl. G06T 13/40; G06T 7/70; G06T 17/00; G06V 40/20

(52) U.S. Cl. CPC G06T 13/40; G06T 7/70; G06T 17/00; G06V 40/23

(57) ABSTRACT

In various examples, artificial intelligence (AI) agents can be generated to synthesize more natural motion by simulated actors in various visualizations (such as video games or simulations). AI agents may employ one or more machine learning models and techniques, such as reinforcement learning, to enable synthesis of motion with enhanced realism. The AI agent can be trained based on widely-available broadcast video data, without the need for more costly and limited motion capture data. To account for the lower quality of such video data, various techniques can be employed, such as taking into account the motion of joints, and applying physics-based constraints on the actors, resulting in higher quality, more lifelike motion.

### CROSS-REFERENCE TO RELATED APPLICATIONS

This application claims the benefit of U.S. Provisional Application No. 63/414,484, filed on Oct. 8, 2022, which is hereby incorporated by reference in its entirety.

### BACKGROUND

Historically, motion capture has been among the most common sources of motion data for character animation. While motion capture is able to provide high quality data, motion capture systems require large capture volumes and highly skilled human actors to provide data usable to generate a realistic simulation, and are thus very time consuming and costly. Since motion capture systems also require (generally) substantial equipment (e.g., green screens, cameras, motion capture suits) to capture well, these systems are generally restricted to controlled areas (sets) with limited capture volumes. However, limited capture volumes (e.g., size limitations of the indoor room or “arena” in which motion capture data is obtained) make it difficult to capture outdoor activities that take place over a larger volume, such as in sports (e.g., soccer and a soccer field). For example, a human actor in a relatively small indoor arena or set would not engage in the sort of movements that would lead to a ball traveling beyond the confines of the indoor arena, even though the real-world activities being simulated by the actors would involve fields that extend beyond the indoor arena. Moreover, motion capture data is limited in the type and quality of the movements that are captured. For example, because professional athletes do not wear smart suits or other motion capture equipment during consequential games against other professional athletes, motion capture data of even professional athletes may not be entirely representative of realistic motion. That is, even if the skilled human actors are highly-skilled professional athletes, the athletes are generally not moving as they would if they were moving in reaction to other highly-skilled opponents in actual competitions, unconstrained by the motion capture equipment. By contrast, humans and other animals are frequently recorded in videos (e.g., when playing sports), and videos of competitive games are relatively more abundant.

### SUMMARY

Embodiments of the present disclosure relate to generating artificial agents to synthesize motion in simulations. Systems and methods are disclosed that enable generation of artificial agents, which may employ one or more machine learning models and techniques to synthesize motion of simulated actors in visualizations. The artificial agents can be generated using broadcast video data.

In contrast to conventional systems, such as those discussed above, the disclosed approach enables high quality, lifelike motion synthesis (e.g., natural and precise human-like motions of, e.g., players in a game or a simulation). The approach can use any videos with moving actors (e.g., broadcast videos, such as videos of sports games or other competitions), and does not require new motion capture data. Even though they may be abundantly available, such videos (e.g., monocular broadcast videos) are often of lower quality as compared to motion capture data, and would not produce natural and precise human-like motions using prior approaches. As used herein, “actor” can refer to any moving living or non-living entity or object, such as humans (e.g., professional athletes or non-athletes), animals (e.g., horses, dogs, or birds), robots, or animate objects with articulating parts. As used herein, “broadcast video” refers to any video that is, or is part of, a show (e.g., a television show), a movie, a sports presentation (e.g., Olympic games), a performance (e.g., dance, tumbling, sleight-of-hand, etc.), or other presentation of an activity. As used herein, “large-scale” is intended to indicate large numbers, extensive, or relative abundance, such as hundreds, thousands, hundreds of thousands, or millions. As used herein, “low-quality” videos are videos that are limited in how much motion information they provide, such as the specific movements of particular joints and other parts, in contrast to motion capture data that provides spatial and temporal data for body parts of actors. As used herein, “monocular” video refers to video captured using one camera at a time.

At least one aspect relates to a processor. In various embodiments, the processor can comprise, or can be, one or more circuits to employ an artificial agent. The artificial agent can be employed to synthesize motion of a simulated character in a visualization. The artificial agent may have been generated by: receiving video data comprising motion by at least one actor; reconstructing movements of the at least one actor in the received video data, the reconstructing the movements comprising extracting a series of estimated kinematic poses for a set of frames in the video data; and training or otherwise updating, through reinforcement learning, based at least on the reconstructed movements, the artificial agent to drive motions of the simulated character in the visualization.

In various embodiments, the artificial agent comprises a generative machine learning model. In various embodiments, the video data comprises monocular broadcast video. In various embodiments, the artificial agent was generated without using new motion capture data. In various embodiments, the reconstructing the movements further comprises applying physics-based constraints to the series of estimated kinematic poses to correct for artifacts in the series of estimated kinematic poses. In various, non-limiting embodiments, the visualization is an interactive game, or a simulation of an environment or scene used for testing of planning, control, and/or perception systems in autonomous machines and devices. In various embodiments, the simulated character may be—for example and without limitation—a player in a sport, a performer in a performance, a participant in an activity, or an actor (e.g., pedestrian, animal) in a simulated environment or scene, etc. In various embodiments, the video data comprises broadcasted events of any one of, or any combination of two or more of, one or more sporting events, one or more performances, and/or one or more activities. In various embodiments, the at least one actor is at least one human or non-human participant of any one of, or any combination of two or more of, one or more sporting events, one or more performances, and/or one or more activities. In various embodiments, the simulated character is a virtual participant of any one or, or any combination of two or more of, one or more sporting events, one or more performances, and/or one or more activities. A specific example scenario as contemplated in accordance with various embodiments, may include video data that comprises broadcasted tennis matches. In such a scenario, the at least one actor may be at least one human tennis player, the simulated character may be a tennis player, and the video data may comprise motion by the at least one actor interacting with at least one object. In various embodiments, the one or more circuits are to further employ the artificial agent to synthesize motion of one or more simulated objects with which the simulated character interacts. In various embodiments, reconstructing the movements provides joint rotation data.

Another aspect relates to a processor. The processor can be, or can comprise, one more circuits to generate an artificial agent to synthesize motion of a simulated character in a visualization. The artificial agent can be generated by: receiving video data comprising motion by at least one actor interacting with at least one object; reconstructing movements of the at least one actor in the received video data, the reconstructing the movements comprising extracting a series of estimated kinematic poses for a set of frames in the video data; and updating, through reinforcement learning, based at least on the reconstructed movements, the artificial agent to drive motions of the simulated character in the visualization.

In various embodiments, the artificial agent comprises a generative machine learning model. In various embodiments, the video data comprises monocular broadcast video. In various embodiments, the artificial agent is generated without using new motion capture data. In various embodiments, the reconstructing the movements further comprises applying physics-based constraints to the series of estimated kinematic poses to correct for artifacts in the series of estimated kinematic poses. In various embodiments, the video data comprises a broadcast of any one of, or any combination of two or more of, one or more sporting events, one or more performances, and/or one or more activities. In various embodiments, the at least one actor is at least one human or non-human participant in any one of, or any combination of two or more of, one or more sporting events, one or more performances, and/or one or more activities. In various embodiments, the simulated character is a virtual participant in an interactive simulation of the sporting event, performance, or activity. In various embodiments, the video data comprises broadcasted tennis matches. In various embodiments, the at least one actor is at least one human tennis player. In various embodiments, the simulated character is a tennis player in an interactive tennis game. In various embodiments, the video data comprises motion by the at least one actor interacting with at least one object. In various embodiments, the artificial agent is generated to further synthesize motion of one or more simulated objects with which the simulated character interacts. In various embodiments, the reconstructing the movements provides joint rotation data. In various embodiments, the one or more circuits are to further use the artificial agent as a controller in an interactive game.

Various embodiments relate to methods of employing an artificial agent as discussed above. Various embodiments relate to methods of training or otherwise updating an artificial agent as discussed above.

In various embodiments, the processors, systems, and/or methods described herein can be implemented by or via, or can be included in, at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for three-dimensional (3D) assets; a system for performing deep learning operations; a system implemented using one or more (large) language models; a system implemented using an edge device; a system implemented using a robot; a system for performing conversational AI operations; a system for generating synthetic data; a system incorporating one or more virtual machines (VMs); a system implemented at least partially in a data center; or a system implemented at least partially using cloud computing resources.

### BRIEF DESCRIPTION OF THE DRAWINGS

The present systems and methods for generating artificial agents to synthesize motion in simulations are described in detail below with reference to the attached drawing figures.

FIG. 1 is a flow diagram of an example process of updating and using an artificial agent, in accordance with some embodiments of the present disclosure.

FIG. 2 is a block diagram of an example computing device suitable for use in implementing some embodiments of the present disclosure.

FIG. 3 is a block diagram of an example content streaming system suitable for use in implementing some embodiments of the present disclosure.

FIG. 4 is a block diagram of an example data center suitable for use in implementing some embodiments of the present disclosure.

FIGS. 5, 6, and 7 present renderings by a system that allows physically-simulated characters to learn diverse and complex tennis skills from motions extracted from large scale, low quality broadcast videos, according to some embodiments of the present disclosure.

FIG. 8 illustrates four stages of an example video imitation system, according to some embodiments of the present disclosure. First, the approach may involve estimating kinematic motions from source video clips. Second, the approach may involve a low-level imitation policy being trained to imitate the kinematic motion for controlling the low-level behaviors of the simulated character and generating physically corrected motion. Third, the approach may involve fitting conditional variational autoencoders (VAEs) to the corrected motion to learn a motion embedding that produces diverse and human-like tennis motions. And fourth, the approach may involve a high-level motion planning policy being trained to generate target kinematic motion by predicting VAE latent codes and wrist joint corrections, and then control a physically-simulated character using the low-level imitation policy.

FIG. 9 illustrates a simulated character model (a), and corresponding visualization model (b), with 24 rigid body segments and 72 degrees-of-freedom, according to some embodiments of the present disclosure. The tennis racket is simplified as the combination of two solid cylinders and the grip is simplified by directly attaching the end of the racket handle to the wrist joint.

FIGS. 10 and 11 depict simulated players demonstrating diverse tennis skills and variations when learned using different players' motion data, with (a)-(d) illustrating the skills learned using Roger Federer's motion data, who is a right-handed player and uses one-hand backhand, (e) and (f) showing the skills learned using Novak Djokovic's motion data, who is also a right-handed player but uses two-hand backhand, and (g) and (h) presenting the skills learned using Rafael Nadal's motion data, who is a left-handed player and uses two-hand backhand, according to some embodiments of the present disclosure, according to some embodiments of the present disclosure.

### DETAILED DESCRIPTION

Systems and methods are disclosed related to generating artificial agents (used interchangeably with artificial intelligence (AI) agents) to synthesize motion in simulations.

In a simulation, increasing the potential possible movements of living creatures and non-living objects helps enhance realism. For example, if a simulated character jumps in exactly the same way every time, regardless of the circumstances of the simulated character, the character tends to appear less lifelike. The more that the movements of creatures and objects adjust to their surroundings (which can include other creatures and objects), the more realistic and natural they appear.

Because the number of potential circumstances that can be experienced by characters in simulations can vary dramatically, artificial intelligence and machine learning can provide more computationally efficient means of synthesizing realistic motions of actors in simulations. Such techniques may involve “teaching” an AI agent (which may employ one or more machine learning models and techniques) to generate movements of actors based on circumstances. The teaching may be accomplished by, for example, “showing” the AI agent a very large number of examples of how creatures and objects move in different situations.

Motion capture techniques could provide high-quality data for training and updating an AI agent, but motion capture is costly (both in terms of expense and time), so motion capture data tends to be small scale (e.g., limited in quantity and variety). Motion capture also is limited in what circumstances it captures because the motion tends to be captured in controlled environments and is not necessarily demonstrative of how the actors would move in a large number of real world circumstances. By contrast, videos with movements of actors can be more plentiful, but they tend to be lower quality. For example, objects in an actor's surroundings can be blocked (e.g., obscured or occluded) from the perspective of the camera, outside of the frame, or otherwise not apparent in videos, making it difficult for an AI agent to learn exactly why an actor moved as it did in a particular circumstance.

The approach discussed here enables generation of artificial agents to synthesize more natural, lifelike motion by simulated actors in various visualizations (such as video games or simulations). The artificial agent can be generated using broadcast video data or other videos that lack the specificity of motion capture data. To account for the potentially lower quality of such video data, various techniques are employed to compensate when there is a lower quality of such videos, such as taking into account the motion of joints, and applying physics-based constraints on the actors, resulting in higher quality, more lifelike motion. Broadcast videos, such as videos of sports games or other competitions and activities, can be plentiful, and the disclosed approach can capitalize on such videos, without requiring more costly motion capture data.

Although this specification discusses a specific application of the disclosed approach to tennis matches, and thus simulation of tennis players, this discussion is not intended to limit the present approach to tennis, to sports, or to human actors.

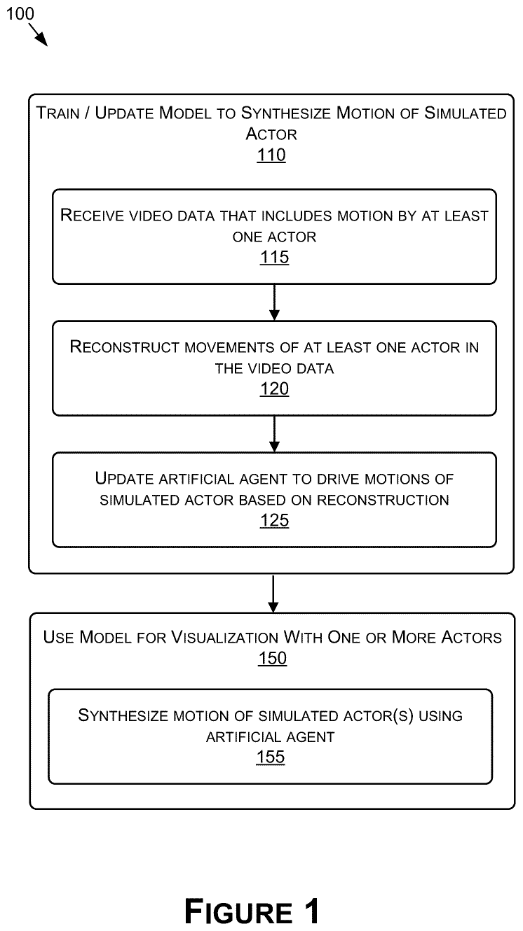

FIG. 1 is an example process, in accordance with some embodiments of the present disclosure. It should be understood that this and other arrangements described herein are set forth only as examples. Other arrangements, steps, and elements (e.g., machines, interfaces, functions, orders, groupings of functions, etc.) may be involved in addition to or instead of those shown, and certain elements or steps may be omitted altogether. Further, many of the elements employed to implement the disclosed approach described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

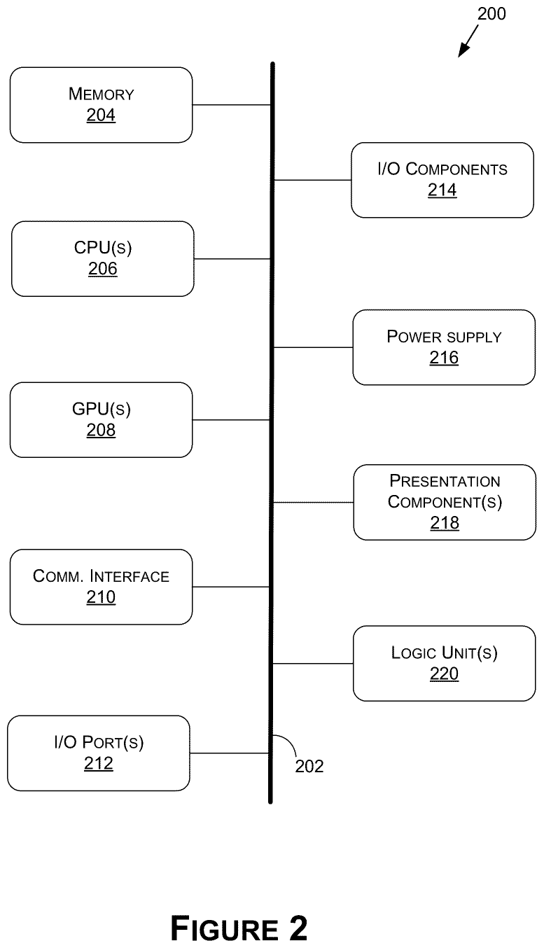

Each block of method 100, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 100 may be implemented using the devices and/or systems of FIGS. 2-4. This method may additionally or alternatively be executed by any one system, or any combination of systems, including, but not limited to, those described herein.

More specifically, FIG. 1 is a flow diagram showing a method 100 for generating artificial agents to synthesize motion in simulations, in accordance with some embodiments of the present disclosure. The method 100, at block 110, includes training or otherwise updating one or more models in generating an artificial agent that is capable of synthesizing motion of one or more simulated actors in a visualization, and at block 150, includes using the models of the artificial agent to synthesize motion of a simulated character in a visualization with one or more actors. The artificial agent may comprise or may employ one or more generative machine learning models generated using one or more machine learning techniques, as further detailed below.

The method 100, at block 115, includes receiving video data that includes motion by one or more actors. As indicated above, the one or more actors can refer to any moving living or non-living entity or object. The video data may comprise, or may be, video of motion by the one or more actors interacting with one or more objects (e.g., a ball, a racket, a vehicle, another character, the ground, a court or field, etc.). The video data may be any video data, and may be, or may include, broadcast videos (though it is not limited to broadcast videos). The video data may be, though it need not be limited to, monocular videos. Advantageously, the artificial agent may be generated without using new motion capture data.

At block 120, the method 100 comprises reconstructing movements of at least one actor in the received video data. Reconstructing movements may be, or may comprise, extracting a series of estimated kinematic poses for a set of frames in the video data. The reconstruction of movements may further comprise applying physics-based constraints to the series of estimated kinematic poses to correct for artifacts in the series of estimated kinematic poses, as further detailed below.

At block 125, the method 100 comprises updating, based at least on the reconstructed movements, the artificial agent to drive motions of the simulated character in the visualization. The artificial agent may be trained or otherwise updated through reinforcement learning. Movement reconstruction may generate, or otherwise provide, joint rotation data (e.g., data on the rotation of wrists or knees of actors). The visualization may be an interactive game, or other simulated video or graphical output (e.g., for testing or validating control, planning, and/or perception systems of an autonomous machine or device). The simulated character may be a player in a sport. The simulated character may be a performer in a performance, or a participant in an activity.

As indicated above, block 155 is part of using an updated artificial agent to simulate motion in a visualization of block 150. At block 155, the artificial agent synthesizes motion of one or more simulated actors. The artificial agent may be used as, for example, a controller in an interactive game (e.g., a sports-related video game). A simulated character may be, though it need not be, a player in a sport. Additionally or alternatively, the artificial agent may be used to synthesize movements of one or more simulated objects with which a simulated character may interact.

In various non-limiting examples, further detailed below but provided as an overview here, the video data may be, or may comprise, broadcasted tennis matches, with the at least one actor being at least one human tennis player. The simulated character could thus be a tennis player. With respect to such non-limiting example implementations, to train characters to have skills using sports videos, implementations of the disclosed approach provide a video imitation system employing four stages, in some potential embodiments of the disclosure. First, kinematic motions may be estimated from source video clips. Second, a low-level imitation policy may be trained to imitate the kinematic motion for controlling the low-level behaviors of the simulated character, and generate physically-corrected motion. Third, conditional VAEs may be fitted to the corrected motion to train a motion embedding that produces human-like tennis motions. Fourth, a high-level motion planning policy is trained to generate target kinematic motion from the motion embedding, and then control a physically-simulated character to perform a desired task.

To build a tennis motion data set from raw videos, the disclosed approach may employ a combination of 2D and 3D pose estimators to reconstruct the players' poses and root trajectories. However, the estimated kinematic motions can be noisy, with jittering and foot skating artifacts. Importantly, the wrist motion for controlling the racket is inaccurate, since it can be difficult to estimate the wrist or the racket motion due to occlusion and motion blur. To address these artifacts, a low-level imitation policy may be trained to control a physically-simulated character to track these noisy kinematic motions and output physically corrected motions. The resulting motions after correction are more physically plausible and stable compared to the original kinematic motions.

With the corrected motion data set, a kinematic motion embedding can be constructed by fitting conditional VAEs to the motion data. Given the same initial pose, diverse motions can be generated by sampling different trajectories of latency. An additional benefit of the motion embedding is that it can help smooth motions and mitigate some of the jittering artifacts in the original motion data.

To address inaccuracies in the wrist joint for precise control of the racket, the disclosed approach may employ a hybrid control structure in which the full body motion is controlled by the reference trajectories from the motion embedding, while the wrist motion is directly controlled by the high-level policy.

In example implementations of the disclosed approach, the artificial agent can learn various tennis skills, such as serve, forehand topspin, backhand top spin, and backhand slice. Skills can be learned, for example, using data from a right-handed player who used a one hand backhand. The simulated character can hit fast coming tennis balls with diverse and complex skills. When given a target spin direction, such as a backspin, the character will hit the ball with a slice.

In the disclosed approach, simulated characters can hit incoming tennis balls close to random target locations with high precision. They can hit the same incoming tennis ball to various target locations, or hit different incoming tennis balls to the same target. In the extreme cases, the simulated characters can still complete the task with exceptional skill, such as hitting consecutive balls that land on the court edges.

When constructing motion embedding with motions from different players, the artificial agent can learn tennis skills in different styles, such as a two-hand backhand swing learned using data from a right-handed player who used a two-hand backhand, or holding the racket with the left hand learned using data from a left-handed player who also used a two-handed backhand. The trained controllers can generate novel animations of tennis rallies between two players. A rally may be generated, for example, using controllers trained using data for two right-handed players, or controllers trained from a left-handed player and a right-handed player.

The physics correction is important to constructing a good motion embedding for generating natural motions. Directly training the embedding from uncorrected kinematic motions is expected to result in physically implausible motion that exhibits artifacts such as foot skating and jittering. It also decreases precision when hitting the tennis balls.

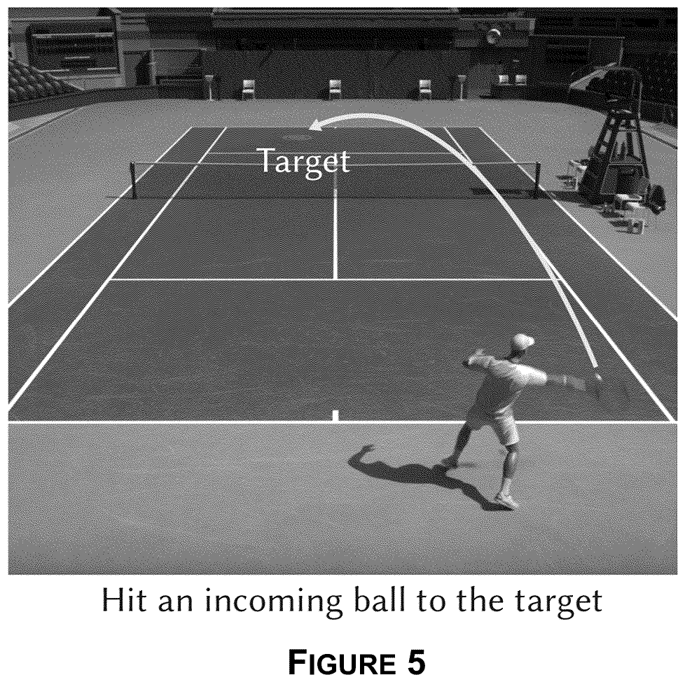

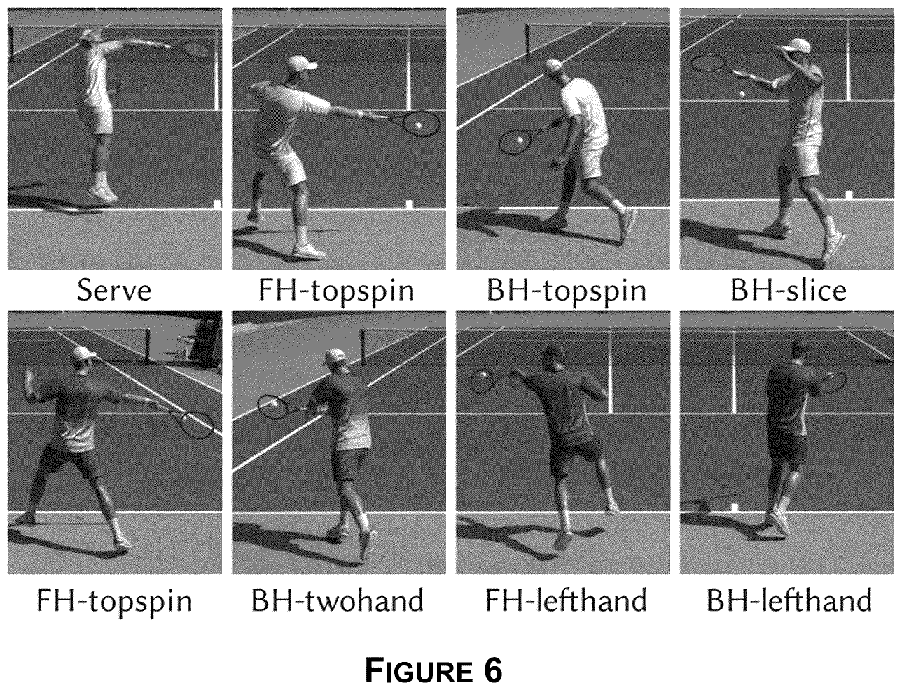

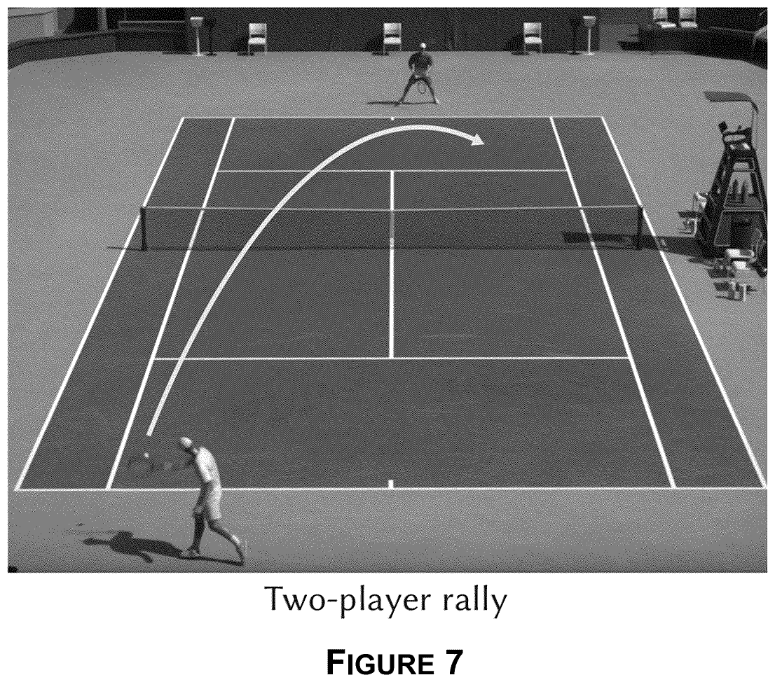

The proposed hybrid control is important for precisely controlling the tennis racket (or other objects with which a character interacts in other example implementations). Without hybrid control to correct the wrist motions, the simulated character may hit the ball but fail to return it close to the target. These will be more fully detailed with respect to the discussion of FIGS. 5-11 below.

### Example Computing Device

FIG. 2 is a block diagram of an example computing device(s) 200 suitable for use in implementing some embodiments of the present disclosure. Computing device 200 may include an interconnect system 202 that directly or indirectly couples the following devices: memory 204, one or more central processing units (CPUs) 206, one or more graphics processing units (GPUs) 208, a communication interface 210, input/output (I/O) ports 212, input/output components 214, a power supply 216, one or more presentation components 218 (e.g., display(s)), and one or more logic units 220. In at least one embodiment, the computing device(s) 200 may comprise one or more virtual machines (VMs), and/or any of the components thereof may comprise virtual components (e.g., virtual hardware components). For non-limiting examples, one or more of the GPUs 208 may comprise one or more vGPUs, one or more of the CPUs 206 may comprise one or more vCPUs, and/or one or more of the logic units 220 may comprise one or more virtual logic units. As such, a computing device(s) 200 may include discrete components (e.g., a full GPU dedicated to the computing device 200), virtual components (e.g., a portion of a GPU dedicated to the computing device 200), or a combination thereof.

Although the various blocks of FIG. 2 are shown as connected via the interconnect system 202 with lines, this is not intended to be limiting and is for clarity only. For example, in some embodiments, a presentation component 218, such as a display device, may be considered an I/O component 214 (e.g., if the display is a touch screen). As another example, the CPUs 206 and/or GPUs 208 may include memory (e.g., the memory 204 may be representative of a storage device in addition to the memory of the GPUs 208, the CPUs 206, and/or other components). In other words, the computing device of FIG. 2 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 2.

The interconnect system 202 may represent one or more links or busses, such as an address bus, a data bus, a control bus, or a combination thereof. The interconnect system 202 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 206 may be directly connected to the memory 204. Further, the CPU 206 may be directly connected to the GPU 208. Where there is direct, or point-to-point connection between components, the interconnect system 202 may include a PCIe link to carry out the connection. In these examples, a PCI bus need not be included in the computing device 200.

The memory 204 may include any of a variety of computer-readable media. The computer-readable media may be any available media that may be accessed by the computing device 200. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 204 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 200. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 206 may be configured to execute at least some of the computer-readable instructions to control one or more components of the computing device 200 to perform one or more of the methods and/or processes described herein. The CPU(s) 206 may each include one or more cores (e.g., one, two, four, eight, twenty-eight, seventy-two, etc.) that are capable of handling a multitude of software threads simultaneously. The CPU(s) 206 may include any type of processor, and may include different types of processors depending on the type of computing device 200 implemented (e.g., processors with fewer cores for mobile devices and processors with more cores for servers). For example, depending on the type of computing device 200, the processor may be an Advanced RISC Machines (ARM) processor implemented using Reduced Instruction Set Computing (RISC) or an x86 processor implemented using Complex Instruction Set Computing (CISC). The computing device 200 may include one or more CPUs 206 in addition to one or more microprocessors or supplementary co-processors, such as math co-processors.

In addition to or alternatively from the CPU(s) 206, the GPU(s) 208 may be configured to execute at least some of the computer-readable instructions to control one or more components of the computing device 200 to perform one or more of the methods and/or processes described herein. One or more of the GPU(s) 208 may be an integrated GPU (e.g., with one or more of the CPU(s) 206 and/or one or more of the GPU(s) 208 may be a discrete GPU. In embodiments, one or more of the GPU(s) 208 may be a coprocessor of one or more of the CPU(s) 206. The GPU(s) 208 may be used by the computing device 200 to render graphics (e.g., 3D graphics) or perform general purpose computations. For example, the GPU(s) 208 may be used for General-Purpose computing on GPUs (GPGPU). The GPU(s) 208 may include hundreds or thousands of cores that are capable of handling hundreds or thousands of software threads simultaneously. The GPU(s) 208 may generate pixel data for output images in response to rendering commands (e.g., rendering commands from the CPU(s) 206 received via a host interface). The GPU(s) 208 may include graphics memory, such as display memory, for storing pixel data or any other suitable data, such as GPGPU data. The display memory may be included as part of the memory 204. The GPU(s) 208 may include two or more GPUs operating in parallel (e.g., via a link). The link may directly connect the GPUs (e.g., using NVLINK) or may connect the GPUs through a switch (e.g., using NVSwitch). When combined together, each GPU 208 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 206 and/or the GPU(s) 208, the logic unit(s) 220 may be configured to execute at least some of the computer-readable instructions to control one or more components of the computing device 200 to perform one or more of the methods and/or processes described herein. In embodiments, the CPU(s) 206, the GPU(s) 208, and/or the logic unit(s) 220 may discretely or jointly perform any combination of the methods, processes and/or portions thereof. One or more of the logic units 220 may be part of and/or integrated in one or more of the CPU(s) 206 and/or the GPU(s) 208 and/or one or more of the logic units 220 may be discrete components or otherwise external to the CPU(s) 206 and/or the GPU(s) 208. In embodiments, one or more of the logic units 220 may be a coprocessor of one or more of the CPU(s) 206 and/or one or more of the GPU(s) 208.

Examples of the logic unit(s) 220 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 210 may include one or more receivers, transmitters, and/or transceivers that enable the computing device 200 to communicate with other computing devices via an electronic communication network, included wired and/or wireless communications. The communication interface 210 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniB and), low-power wide-area networks (e.g., LoRaWAN, SigFox, etc.), and/or the Internet. In one or more embodiments, logic unit(s) 220 and/or communication interface 210 may include one or more data processing units (DPUs) to transmit data received over a network and/or through interconnect system 202 directly to (e.g., a memory of) one or more GPU(s) 208.

The I/O ports 212 may enable the computing device 200 to be logically coupled to other devices including the I/O components 214, the presentation component(s) 218, and/or other components, some of which may be built in to (e.g., integrated in) the computing device 200. Illustrative I/O components 214 include a microphone, mouse, keyboard, joystick, game pad, game controller, satellite dish, scanner, printer, wireless device, etc. The I/O components 214 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 200. The computing device 200 may be include depth cameras, such as stereoscopic camera systems, infrared camera systems, RGB camera systems, touchscreen technology, and combinations of these, for gesture detection and recognition. Additionally, the computing device 200 may include accelerometers or gyroscopes (e.g., as part of an inertia measurement unit (IMU)) that enable detection of motion. In some examples, the output of the accelerometers or gyroscopes may be used by the computing device 200 to render immersive augmented reality or virtual reality.

The power supply 216 may include a hard-wired power supply, a battery power supply, or a combination thereof. The power supply 216 may provide power to the computing device 200 to enable the components of the computing device 200 to operate.

The presentation component(s) 218 may include a display (e.g., a monitor, a touch screen, a television screen, a heads-up-display (HUD), other display types, or a combination thereof), speakers, and/or other presentation components. The presentation component(s) 218 may receive data from other components (e.g., the GPU(s) 208, the CPU(s) 206, DPUs, etc.), and output the data (e.g., as an image, video, sound, etc.).

### Example Content Streaming System

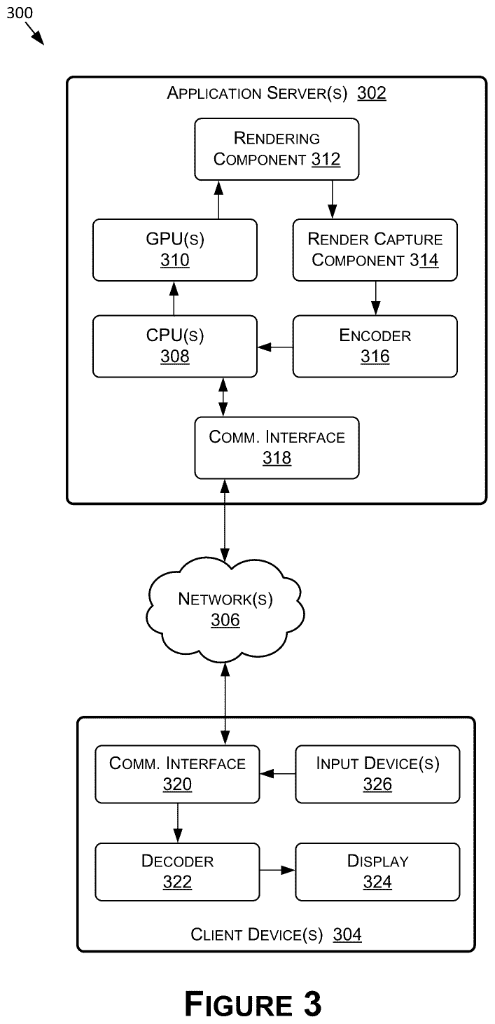

Now referring to FIG. 3, FIG. 3 is an example system diagram for a content streaming system 300, in accordance with some embodiments of the present disclosure. FIG. 3 includes application server(s) 302 (which may include similar components, features, and/or functionality to the example computing device 200 of FIG. 2), client device(s) 304 (which may include similar components, features, and/or functionality to the example computing device 200 of FIG. 2), and network(s) 306 (which may be similar to the network(s) described herein). In some embodiments of the present disclosure, the system 300 may be implemented. The application session may correspond to a game streaming application (e.g., NVIDIA GeFORCE NOW), a remote desktop application, a simulation application (e.g., autonomous or semi-autonomous vehicle simulation), computer aided design (CAD) applications, virtual reality (VR) and/or augmented reality (AR) streaming applications, deep learning applications, and/or other application types.

In the system 300, for an application session, the client device(s) 304 may only receive input data in response to inputs to the input device(s), transmit the input data to the application server(s) 302, receive encoded display data from the application server(s) 302, and display the display data on the display 324. As such, the more computationally intense computing and processing is offloaded to the application server(s) 302 (e.g., rendering—in particular ray or path tracing—for graphical output of the application session is executed by the GPU(s) of the game server(s) 302). In other words, the application session is streamed to the client device(s) 304 from the application server(s) 302, thereby reducing the requirements of the client device(s) 304 for graphics processing and rendering.

For example, with respect to an instantiation of an application session, a client device 304 may be displaying a frame of the application session on the display 324 based on receiving the display data from the application server(s) 302. The client device 304 may receive an input to one of the input device(s) and generate input data in response. The client device 304 may transmit the input data to the application server(s) 302 via the communication interface 320 and over the network(s) 306 (e.g., the Internet), and the application server(s) 302 may receive the input data via the communication interface 318. The CPU(s) may receive the input data, process the input data, and transmit data to the GPU(s) that causes the GPU(s) to generate a rendering of the application session. For example, the input data may be representative of a movement of a character of the user in a game session of a game application, firing a weapon, reloading, passing a ball, turning a vehicle, etc. The rendering component 312 may render the application session (e.g., representative of the result of the input data) and the render capture component 314 may capture the rendering of the application session as display data (e.g., as image data capturing the rendered frame of the application session). The rendering of the application session may include ray or path-traced lighting and/or shadow effects, computed using one or more parallel processing units—such as GPUs, which may further employ the use of one or more dedicated hardware accelerators or processing cores to perform ray or path-tracing techniques—of the application server(s) 302. In some embodiments, one or more virtual machines (VMs)—e.g., including one or more virtual components, such as vGPUs, vCPUs, etc.—may be used by the application server(s) 302 to support the application sessions. The encoder 316 may then encode the display data to generate encoded display data and the encoded display data may be transmitted to the client device 304 over the network(s) 306 via the communication interface 318. The client device 304 may receive the encoded display data via the communication interface 320 and the decoder 322 may decode the encoded display data to generate the display data. The client device 304 may then display the display data via the display 324.

In example implementations, the disclosed approach allows physically-simulated characters to learn diverse and complex tennis skills from broadcast tennis videos. In such implementations, simulated characters can hit consecutive incoming tennis balls with a variety of tennis skills, such as serve, forehand, backhand, topspin, and slice. The motions generated resemble those of human players. The controllers can also be trained using different players' motion data, enabling the characters to adopt different playing styles.

The systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems implemented at least partially using cloud computing resources, and/or other types of systems.

### Example Data Center

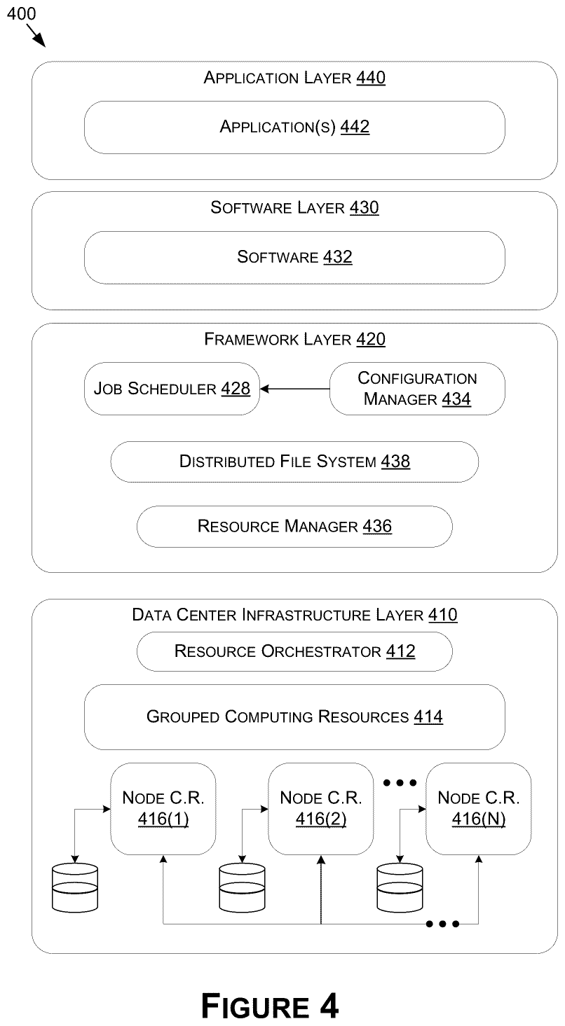

FIG. 4 illustrates an example data center 400 that may be used in at least one embodiments of the present disclosure. The data center 400 may include a data center infrastructure layer 410, a framework layer 420, a software layer 430, and/or an application layer 440.

As shown in FIG. 4, the data center infrastructure layer 410 may include a resource orchestrator 412, grouped computing resources 414, and node computing resources (“node C.R.s”) 416(1)-416(N), where “N” represents any whole, positive integer. In at least one embodiment, node C.R.s 416(1)-416(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 416(1)-416(N) may correspond to a server having one or more of the above-mentioned computing resources. In addition, in some embodiments, the node C.R.s 416(1)-4161(N) may include one or more virtual components, such as vGPUs, vCPUs, and/or the like, and/or one or more of the node C.R.s 416(1)-416(N) may correspond to a virtual machine (VM).

In at least one embodiment, grouped computing resources 414 may include separate groupings of node C.R.s 416 housed within one or more racks (not shown), or many racks housed in data centers at various geographical locations (also not shown). Separate groupings of node C.R.s 416 within grouped computing resources 414 may include grouped compute, network, memory or storage resources that may be configured or allocated to support one or more workloads. In at least one embodiment, several node C.R.s 416 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 412 may configure or otherwise control one or more node C.R.s 416(1)-416(N) and/or grouped computing resources 414. In at least one embodiment, resource orchestrator 412 may include a software design infrastructure (SDI) management entity for the data center 400. The resource orchestrator 412 may include hardware, software, or some combination thereof.

In at least one embodiment, as shown in FIG. 4, framework layer 420 may include a job scheduler 428, a configuration manager 434, a resource manager 436, and/or a distributed file system 438. The framework layer 420 may include a framework to support software 432 of software layer 430 and/or one or more application(s) 442 of application layer 440. The software 432 or application(s) 442 may respectively include web-based service software or applications, such as those provided by Amazon Web Services, Google Cloud and Microsoft Azure. The framework layer 420 may be, but is not limited to, a type of free and open-source software web application framework such as Apache Spark™ (hereinafter “Spark”) that may utilize distributed file system 438 for large-scale data processing (e.g., “big data”). In at least one embodiment, job scheduler 428 may include a Spark driver to facilitate scheduling of workloads supported by various layers of data center 400. The configuration manager 434 may be capable of configuring different layers such as software layer 430 and framework layer 420 including Spark and distributed file system 438 for supporting large-scale data processing. The resource manager 436 may be capable of managing clustered or grouped computing resources mapped to or allocated for support of distributed file system 438 and job scheduler 428. In at least one embodiment, clustered or grouped computing resources may include grouped computing resource 414 at data center infrastructure layer 410. The resource manager 436 may coordinate with resource orchestrator 412 to manage these mapped or allocated computing resources.

In at least one embodiment, software 432 included in software layer 430 may include software used by at least portions of node C.R.s 416(1)-416(N), grouped computing resources 414, and/or distributed file system 438 of framework layer 420. One or more types of software may include, but are not limited to, Internet web page search software, e-mail virus scan software, database software, and streaming video content software.

In at least one embodiment, application(s) 442 included in application layer 440 may include one or more types of applications used by at least portions of node C.R.s 416(1)-416(N), grouped computing resources 414, and/or distributed file system 438 of framework layer 420. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 434, resource manager 436, and resource orchestrator 412 may implement any number and type of self-modifying actions based on any amount and type of data acquired in any technically feasible fashion. Self-modifying actions may relieve a data center operator of data center 400 from making possibly bad configuration decisions and possibly avoiding underutilized and/or poor performing portions of a data center.

The data center 400 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 400. In at least one embodiment, trained or deployed machine learning models corresponding to one or more neural networks may be used to infer or predict information using resources described above with respect to the data center 400 by using weight parameters calculated through one or more training techniques, such as but not limited to those described herein.

In at least one embodiment, the data center 400 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 200 of FIG. 2—e.g., each device may include similar components, features, and/or functionality of the computing device(s) 200. In addition, where backend devices (e.g., servers, NAS, etc.) are implemented, the backend devices may be included as part of a data center 400, an example of which is described in more detail herein with respect to FIG. 4.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 200 described herein with respect to FIG. 2. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

With reference to FIGS. 5-11, which focus on the non-limiting example of tennis and synthesis of movements by simulated tennis players, motion capture data has been the most popular data source for computer animation techniques that combine deep reinforcement learning and motion imitation to produce lifelike motions and perform diverse skills. However, motion capture data for specialized skills can be costly to acquire at scale while there exists an enormous corpus of athletic motion data in the form of video recordings. The disclosed approach may train an artificial agent to, for example, exhibit diverse and complex tennis skills leveraging large-scale but lower-quality motions harvested from broadcast videos, for physically-simulated characters to play tennis rallies. A video imitation system may be built upon hierarchical models, combining a low-level imitation policy and a high-level motion planning policy to steer the character in a motion space learned from large video datasets, so that complex skills such as hitting tennis balls with different types of shots and spins can be learned using only simple rewards and without explicit annotations of the action types. Specifically, the disclosed approach addresses low-quality demonstrations by correcting the estimated motion with physics-based imitation. The corrected motion is then used to construct a motion embedding that can produce diverse human-like tennis motions.

Additionally, the disclosed approach may employ an important hybrid control method that combines imperfect motion (e.g., inaccurate wrist motion) from the motion embedding with joint correction predicted by the high-level policy to accomplish the task better. The disclosed approach can produce controllers for physically-simulated tennis players that can hit the incoming ball to target positions accurately using diverse skills, such as serves, forehands and backhands, topspins and slices. Notably, the disclosed approach can synthesize novel animation of extended tennis rallies between two simulated characters with different playing styles.

Developing controllers for physics-based character simulation and control is one of the core challenges of computer-assisted animation. Prior approaches employed motion capture data as the source of kinematic motions to imitate. In contrast, video of athletic events is widely available and provides a rich source of in-activity motion data. Unlike motion capture data, video streams provide examples of the full range of motion and skills an athlete must perform in a sport: not just salient actions (hitting a shot in tennis), but the complex and subtle motions athletes use to transition between these movements.

Furthermore, the ability to acquire large amounts of video allows examples of many variations of each action to be observed (hitting a high ball or a low ball, reacting quickly or slowly). Moreover, the variations of each action can be observed under a variety of circumstances (e.g., positioning and prior positioning on the court, positioning of other athletes). Some embodiments of the disclosed approach: (1) leverage large-scale but lower-quality databases of 3D tennis motion, harvested from broadcast videos of professional play, to produce controllers that can accomplish a challenging athletic task: playing full tennis rallies; (2) leverage state-of-the-art methods in data-driven and physically-based character animation to help artificial agents learn skills from video data; and/or (3) train character controllers with a diverse set of skills without explicit skill annotations, such as hitting different types of shots (serves, forehands, backhands), employing different spins (topspin, slice), and recovering to prepare for the next shot.

Embodiments of the disclosed approach employ hierarchical physics-based character control: leveraging motions produced by physics-based imitation of example videos to train an artificial agent to produce a rich motion embedding for tennis actions, and then training a high-level motion controller that steers the character in the latent motion space to achieve higher-level task objectives (e.g., hitting an incoming tennis ball), with low-level movements controlled by the imitation controller. To address motion quality issues caused by perception errors that persist in the trained motion embedding (e.g., blurred or occluded wrist joint motion, inaccurate neck rotations), embodiments of the disclosed pipeline override erroneous reference motion with physics-based corrections driven by high-level task rewards or by using simple kinematic constraints specific to tennis (e.g., players should keep their eye on the ball).

The disclosed approach can generate controllers for physically-simulated tennis players that can hit the ball to target positions on the court with high accuracy and can successfully conduct competitive rally play that includes a range of shot types and spins, as shown in FIG. 5. Specifically, various embodiments train models to exhibit diverse and complex tennis skills from broadcast videos. A video imitation system can be built upon hierarchical models, with the system combining a low-level imitation policy and a high-level motion planning policy to steer the character in a motion embedding learned from large video datasets, so that complex skills such as hitting tennis balls with different types of shots and spins can be learned with simple rewards and without explicit annotations of these action types.

Various embodiments employ a motion reconstruction pipeline for building motion embeddings with higher motion quality by using physics priors. Some embodiments of the disclosure employ a full pipeline to reconstruct physically plausible tennis motion from monocular broadcast videos, with physics-based imitation. Constructing the motion embedding using physically corrected motions leads to more natural motions and better task performance than training an embedding directly from the results of kinematic pose estimators without physics correction.

Various embodiments provide a hybrid approach for building motion controller from imperfect motion data. The hybrid approach complements motion reconstruction from videos with reinforcement learning (RL)-based skill learning, which mitigates issues due to artifacts in the reconstructed motions (e.g., inaccurate wrist motion) by using corrections predicted by a high-level policy to accomplish the desired task.

FIGS. 5, 6, and 7 provide renderings of physically-simulated characters trained to perform diverse and complex tennis skills from motions extracted from broadcast videos. Simulated characters can hit consecutive incoming tennis balls close to target locations with high accuracy. A variety of tennis skills can be performed with motions that resemble those of human players, such as serves, forehand/backhand topspins, and backhand slices. The controllers can also be trained using motion data from different players to adopt different playing styles, such as two-hand backhands or left-handed play, which enables synthesis of two players rallying against each other.

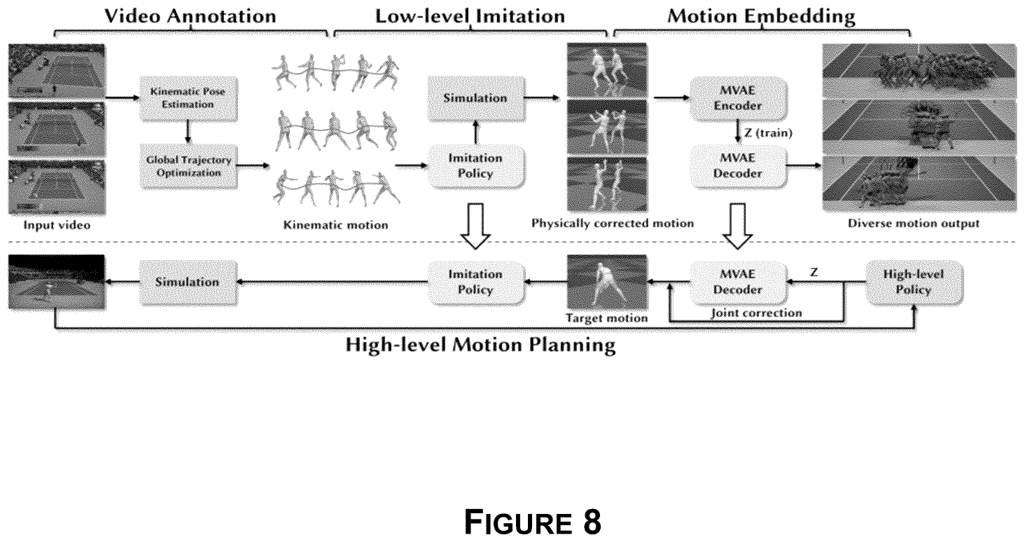

FIG. 8 illustrates an overview of some embodiments of the disclosed approach. The system may take the input of unannotated broadcast tennis videos of different players, and output controllers for physically-simulated characters to hit consecutive incoming tennis balls with diverse and complex tennis skills. The controllers can be used to produce 3D character animation depicting two simulated characters playing tennis rallies.

As illustrated in FIG. 8, an example system comprises four stages, which are further discussed below. In the first stage, the system estimates 2D and 3D player poses and global root trajectories to create a kinematic motion dataset. In the second stage, a low-level imitation policy is trained to imitate the kinematic motion for controlling the low-level behaviors of the simulated character and generate a physically corrected motion dataset. In the third stage, the system fits a conditional VAE to the corrected motion dataset to learn a low-dimensional motion embedding that produces human-like tennis motions. In the fourth stage, a high-level motion planning policy is trained to generate target kinematic motion by combining body motion output from the motion embedding and predicted correction for the wrist joint, which is used to control the physically-simulated character to perform the desired task.

In an example implementation, to build a tennis motion dataset from the raw match videos, automated machine annotations may be utilized to estimate players' kinematic motions from a broadcast camera view, with manual annotations for players' identities and racket-ball contact times.

Player Tracking and Pose Estimation: Example implementations may track the players and estimate their 2D/3D poses from the broadcast videos by using detection models such as Yolo4 (Bochkovskiy et al., 2020, “Yolov4: Optimal speed and accuracy of object detection”) to track players on both sides of the court to obtain point boundaries and player bounding boxes. Two-dimensional pose keypoints may be extracted using, for example, “ViTPose” (Xu et al., 2022, “ViTPose: Simple Vision Transformer Baselines for Human Pose Estimation”). Example implementations may use HybrIK (Li et al., 2021, “Hybrik: A hybrid analytical-neural inverse kinematics solution for 3d human pose and shape estimation”) to estimate the body shape and pose parameters for SMPL (skinned multi-person linear model), where the player bounding boxes are used to crop the images around the player before being provided as input to the pose estimator.

Global root trajectory and camera estimation: Since HybrIK only outputs root position and orientation in the camera coordinates, those quantities are converted to the global court coordinates, with the origin located at the center of the court. Example implementations may estimate the camera projection using a method based on the method of Farin et al. (2003, “Robust camera calibration for sport videos using court models”) to detect court lines and their intersections, and then solve for the camera matrix with the Perspective-N-Point algorithm. The camera transformation can then be used to obtain the global root orientation. To estimate the player's global root position, instead of using the translation from the camera transformation, example implementations first compute the 2D position of the player's root projected onto the ground (center of two ankle keypoints), then transform the location into court coordinates with the inverse camera projection. Example implementations further correct the root trajectory by solving an optimization problem similar to Global Occlusion-Aware Human Mesh Recovery with Dynamic Cameras (GLAMR) to minimize the re-projection error between 2D keypoints and projected 3D joint positions. Example implementations estimate the motion of the near-sided player, as the pose and depth estimation for the far-sided player are less reliable. The kinematic motion dataset obtained from this stage is referred to as [symbol] ₖᵢₙ.

Manual Annotations: To facilitate modeling the phase of the tennis motion when learning the motion embedding (discussed below), example implementations manually label the time when a player makes ball contact. In practice, in various embodiments, labeling only 20% of the total shots may be sufficient for the model to generalize to the rest of the motion dataset when learning the motion embedding due to the repetitive structure of tennis motion. Although example implementations may include manually labeling ball contact times, this labeling process may be automated with high accuracy using computer vision techniques. To train the styles of different players, example implementations manually annotated the player identity for each motion sequence.

### Low-Level Imitation Policy

Since the estimated kinematic motion is obtained without explicit modeling of human dynamics, it will contain physically implausible motions such as jittering, foot skating, and ground penetration. To correct these artifacts, example implementations train a low-level imitation policy to control a physically-simulated character to track this noisy kinematic motion and output physically corrected motion. In addition to its use for motion reconstruction, the low-level policy is also used to control the low-level movements of the simulated character to perform new tasks by tracking the target kinematic trajectories from the high-level motion planning policy (discussed below).

In example implementations, the task of controlling the character agent in a physically-simulated environment to mimic reference motions can be formulated as a Markov decision process (MDP), defined by a tuple [symbol] =( [symbol] , [symbol] , [symbol] , [symbol] , γ) of states, actions, transition dynamics, a reward function, and a discount factor. Example implementations first initialize the state of the simulated character s₀ to be the same initial state of the kinematic motion. Starting from s₀, the agent iteratively samples actions aₜ∈ [symbol] according to a policy π(aₜ|sₜ) at each state sₜ∈ [symbol] . The environment then transitions to the next state sₜ₊₁ according to the transition dynamics [symbol] (sₜ₊₁|sₜ, aₜ), and then outputs a scalar reward rₜ for that transition. The reward is computed based on how well the simulated motion aligns with the ground-truth motion. The goal of this training process is to learn an optimal policy π* that maximizes the expected return J(π)= [symbol] _{π}[Σₜγ^{t}rₜ]. Next, the details of the state, action, and reward function, as well as training strategy of the low-level policy, is described.

States: The simulated character model may be based on the SMPL format in example implementations, with body shape parameters estimated using HybrIK. The character includes 24 rigid bodies and 72 degrees of freedom. Example implementations use the following features to represent the character state sₜ=(pₜ, \dot{p}ₜ, qₜ, \dot{q}ₜ, \tilde{p}ₜ₊₁, \tilde{q}ₜ₊₁):
pₜ: joint positions in the character's root coordinates
\dot{p}ₜ: joint linear velocities in the character's root coordinates
qₜ: joint rotations in the joints' local coordinates
\dot{q}ₜ: joint angular velocities in the joints' local coordinates
\tilde{p}ₜ₊₁: target (kinematic) joint positions
\tilde{q}ₜ₊₁: target (kinematic) joint rotations

Actions: Similar to many prior systems, example implementations use proportional derivative (PD) controllers at each non-root joint to produce torques for actuating the character's body. The action aₜ specifies the target joint angles uₜ for the PD controllers. At each simulation step, the joint torques τₜ are computed as:

τₜ=kₚ·(uₜ−qₜ^{nr})−k_{d}·\dot{q}ₜ^{nr}, (1)
where kₚ and kₚ denote the parameters of the PD controllers that determine the stiffness and damping of each joint, qₜ^{nr} and \dot{q}ₜ^{nr} are the joint rotations and angular velocities of the non-root joints. To improve tracking performance on highly agile motions, one or more embodiments may also apply external residual forces to the root. Therefore, the actions also include residual forces and torques ηₜ for the root joint, and each action is defined as aₜ=(uₜ, ηₜ).

Rewards: The reward function is designed to encourage the policy to closely track the reference motion while also minimizing energy expenditure. The reward consists of five terms:

rₜ=ωₒrₜ^{o}+ωᵥrₜ^{v}+ωₚrₜ^{p}+ωₖrₜ^{k}+ωₑrₜ^{e}. (2)

The rewards rₜ^{o}, rₜ^{v}, and rₜ^{p} measure the differences between the simulated motion and the reference motion in joint rotations, velocities, and positions respectively. The reward rₜ^{k} encourages the projection of the 3D joint positions xₜ to match the detected 2D keypoints \hat{x}ₜ. The last reward rₜ^{e} denotes the power penalty computed as −Σⱼ₌₁^{J}∥\dot{q}ₜ^{j}·τₜ^{j}∥² where τₜ^{j} is the internal torque applied on the j. The weights ωₒ, ωᵥ, ωₚ, ωₖ and ωₑ for each reward term are manually specified in example implementations.

Training: The training of the low-level policy is conducted in two stages in example implementations. In the first stage, example implementations may train the policy with a high-quality motion capture database (e.g., Archive of Motion Capture As Surface Shapes (AMASS)) to learn to imitate general motions. However, directly applying this policy to track noisy estimated tennis motion will lead to the character falling after a few steps of simulation due to domain shift. Therefore, example implementations fine-tune the policy using the estimated kinematic motion so that it can track the tennis motion more closely without falling. The power penalty is only applied during this fine-tuning stage to mitigate the impact of high-frequency noise from the estimated motion. Once trained, example implementations can simply run the low-level policy to track each kinematic motion sequence from [symbol] ₖᵢₙ and export the physically corrected tennis motion dataset, referred as [symbol] _{corr}. In addition to using the low-level imitation policy to correct artifacts in the motion data, the low-level policy is then also used to construct a control hierarchy that enables a physically-simulated character to perform new tasks (discussed further below). More details of the rewards, network architecture, and training hyper-parameters can be found in the Supplementary Material section below.

### Motion Embedding

Once a low-level imitation policy has been trained and used to create a physically corrected motion dataset [symbol] _{corr}, example implementations next proceed to build a kinematic motion embedding model, which will then allow a high-level motion planning policy to plan long-term and lifelike behaviors for performing tennis-related tasks. This generative model may be instantiated (in example, non-limiting embodiments) using conditional VAEs, which learns a low-dimensional latent space using [symbol] _{corr}.

The motion embedding model in example implementations is based on the motion VAE (MVAE) model. Given the current character pose and an input latent variable, representing possible transitions from the current pose, MVAE predicts the pose in the next time step. Similar to standard conditional VAEs, the training process aims to shape the latent variable z into a normal distribution while reconstructing the next pose given the current pose. At run-time, the encoder is discarded, and the decoder takes the input of the current pose and a latent z sampled from the normal distribution to produce the next pose. The predicted next pose can be used as the input in the next step to generate a sequence of poses autoregressively. Example implementations make two important adaptations of MVAE: (1) condition on pose features in global court coordinates to prevent global drift and (2) adapt the model to also predict the motion phase to simplify the design of the reward functions of the high-level policy. Next, details of the pose representation and training setup for the motion embedding model, focusing on our proposed adaptations, is discussed.

Pose Representation: In example implementations, the pose in each frame is represented using the following features:
qₜ^{r}: root orientation in the global court coordinates
rₜ: root position in the global court coordinates
\dot{r}ₜ: root linear velocity in the global court coordinates
pₜ: joint positions relative to the root in global court coordinates
\dot{p}ₜ: linear joint velocities in the global court coordinates
qₜ: joint rotations in the local joint coordinates

It is noted that the positions/orientations in the global court coordinates provide a strong prior to the tennis motion in example implementations. For example, backhand motions are more likely to be performed on the left side of the court for a right-handed player, and players should be facing toward the net after each shot. Therefore, the global root position is added to the pose features and joint features are also represented in the global court coordinates, instead of the egocentric coordinates used by the original MVAE model. In example implementations, conditioning on global positions/orientations helps generate motion that can more consistently recover back toward the court center and face toward the net after recovering to the ready pose.

Motion Phase: When utilizing the motion embedding to plan long-term motion via the high-level policy, the reward functions can be significantly simplified if the phase of the current kinematic pose is known, such as when it gets close to the contact time during a swing. Given the motion phase, the reward can be designed to minimize the distance between the racket and the ball at the contact time. Therefore, example implementations adapt MVAE to also predict the motion phase for the output pose. Specifically, example implementations represent the motion phase at each frame with a cyclic phase variable θ in [0, 2π) based on the shot-cycle state machine from Vid2Player. θ=π denotes when the player makes ball contact and θ=0 or θ=2π denotes when the player recovers (the opponent makes ball contact). The phase for the rest of the frames is linearly interpolated between the neighboring two anchors. To avoid discontinuity at θ=2π, example implementations encode the motion phase with sin θ and cos θ.

Training: Example implementations follow a network design and general training setup of MVAE and incorporate a number of strategies that are important to successfully train a model on the reconstructed tennis motions. Since the input motion data is still noisier than motion capture data, MVAE tends to be more susceptible to error accumulation when generating longer sequences at run-time. To improve the stability of the autoregressive predictions, example implementations adopt scheduled sampling. In experiments, the selection of the coefficient β for the Kullback-Leibler (KL) divergence loss is important for learning a good motion embedding for use by the high-level policy. When β is too large, the decoder will ignore the latent variable z and only playback the original motion data. When β is too small, MVAE may overgeneralize and produce implausible motions with clear artifacts such as foot skating. Empirically, β=0.5 effectively balances the flexibility and motion quality of the learned motion embedding in example implementations. More details of the training process are provided in the Supplementary Material below.

### High-Level Motion Planning Policy

Once the motion embedding has been trained to generate diverse and lifelike tennis motions, it can then be used to synthesize new motions for the character to perform new tasks, such as hitting an incoming tennis ball to various target locations. This can be done by training a separate high-level motion planning policy, which selects latents from the motion embedding to generate kinematic motion trajectories that resemble human behaviors in the data. The output kinematic motions can then be used as target reference trajectories to drive a physically-simulated character with the low-level imitation policy trained (as discussed above at “Low-Level Imitation Policy”). However, directly applying the aforementioned approach generally may not lead to successful shots that hit the ball back to the other side of the court. This is due to inaccuracies in the estimated wrist and racket motions in the dataset, since these nuanced movements may not be accurately predicted from videos due to occlusion and motion blur, especially during the fast tennis swing motion.

To address the inaccuracies in the reconstructed motion data, example implementations use a hybrid control approach where the full-body motion is controlled by the reference trajectories generated by the MVAE, while the wrist joint motion is directly controlled by the high-level policy. To effectively and efficiently optimize the high-level policy, example implementations employ a curriculum curated for this task, where the difficulty of the task gradually increases from reaching the ball, hitting the ball to pass the net, and finally returning the ball close to the desired target location. Furthermore, there are other inaccuracies in the reconstructed tennis motion such as the player's eyes not tracking the ball and the free hand not being on the racket during a two-hand swing. Addressing these artifacts would require additional reward engineering, so example implementations may employ alternative solutions using simple kinematic constraints specific to tennis. In the following, the details of the high-level policy and kinematic constraints for improving the realism of the generated motions in example implementations will be discussed.

Policy Representation: In example implementations, the problem of jointly optimizing the predicted MVAE latent codes as well as the predicted joint corrections can be formulated as an MDP and solved with reinforcement learning. Here, details of the state and action representations used for the high-level policy will be provided.

States: The state includes a set of features that describes the character state, ball state, and control targets specified by the system. The character state shares the same pose representation used for the MVAE, as detailed in the “Motion Embedding” section above, but some (e.g., all) features may be computed from the simulated character. In example implementations, the ball state is represented using the ball's position in the next 10 frames (including the current position), which provides the policy with a forecast of the ball's future trajectory. The future trajectory of the ball is estimated using a pre-computed look-up table of ball trajectories, given the ball's launch velocity, spin, and height (more details can be found in the Supplementary Material section below). Finally, example implementations specify control targets as the ball's target bounce position and a binary variable indicating the desired spin direction of the outgoing shot (topspin or backspin).

Actions: Each action includes two components: a latent code for MVAE to generate a kinematic target pose for the next frame, and joint corrections for the swing arm. The joint corrections include three Euler angles: two for the wrist joint (excluding the twist angle since the twist is limited for the wrist), and the twist angle for the elbow joint. The joint corrections substitute the rotations from the MVAE-produced pose, and the final corrected pose is used as the kinematic target pose for the low-level imitation policy to track.

Reward Function: Example implementations apply a framework to train control policies that enable the simulated character to hit an incoming tennis ball to a desired target bounce location with a target spin direction. This objective is represented using two reward functions specified for stages before and after the racket-ball contact. Before contact, example implementations apply the racket position reward rₜ^{p} to minimize the distance between the center of the racket head xₜ^{r} and the ball position xₜ^{b} when the player hits the ball (predicted motion phase θₜ gets close to π). The racket position reward rₜ^{p} can be represented as:

rₜ^{p}=exp(−βₚ∥xₜ^{r}−xₜ^{b}∥²)·exp(−βₐ∥θₜ−π∥²). (3)

where βᵣ and βₐ are scaling factors. After contact, example implementations apply the ball position reward rₜ^{b} to minimize the distance between the estimated ball bounce position \tilde{x}^{b} and the target bounce position \tilde{x}^{b} while ensuring the ball spins in the right direction as the target spin direction. The ball position reward rₜ^{b} can be represented as:

$${r}_{t}^{b} = \{ \begin{matrix}0 & if {s}^{b} \neq {\hat{s}}^{b} \\ exp ( - {β}_{b} {‖ {\tilde{x}}^{b} - {\hat{x}}^{b} ‖}^{2} ) & if {s}^{b} = {\hat{s}}^{b}\end{matrix} \qquad ( 4 )$$

where s^{b} and ŝ^{b} are binary variables that represent the simulated and target ball spin direction, respectively. A value of 1 denotes topspin (the ball spins forward) and a value of 0 denotes backspin (the ball spins backward). Example implementations can estimate the ball bounce position right after the racket-ball contact by using the ball trajectory look-up table, similar to estimating the incoming ball trajectory, and the same reward is applied at every time step after contact.

Training: Example implementations employ a training strategy as follows. At the beginning of each episode, the character is initialized at a random court position near the baseline in a ready pose. The incoming balls are launched every 2 to 2.5 seconds from positions near the baseline of the opponent side, with a launch velocity between 25 to 35 meters per second, and a launch spin between 0 to 50 revolutions per second. The ball can bounce anywhere between the service line and the baseline of the player's side, which covers a wide variety of incoming ball trajectories. To enable learning of the serve skill, example implementations can also initialize the character at a pre-service state and initialize the ball to be thrown into the air, at the beginning of the training episode. The maximum episode length is set to be 300 frames (10 s) which allows the player to practice four consecutive shots in each episode. In example implementations, simulating multiple shots per episode leads to better performance compared to only one shot per episode.

Curriculum Learning: To effectively and efficiently optimize the high-level policy, example implementations adopt a curriculum that gradually increases the difficulty of the task over time. In the first stage of the curriculum, the objective is to quickly explore the motion embedding and control the player to move in the right direction so that the racket gets close to the incoming ball. Therefore, example implementations train the policy only with the racket position reward rₜ^{p}, and use a larger learning rate (1e⁻⁴), higher action distribution variance Σ_{π} (0.25), and a lower simulation frequency (120 Hz) for faster simulation. In the second stage of the curriculum, the goal is to control the racket so that the ball can be returned to the other side, where the target position is simplified as one of the three fixed positions at the left, center, and right of the court. In this stage, the policy is trained using both rewards with a higher weight on rₜ^{b} (0.9), and use a smaller learning rate (2e⁻⁵), a lower Σ_{π} (0.04), and a higher simulation frequency (360 Hz) to ensure the extremely fast racket-ball contact process is accurately simulated. Finally, the last stage of the curriculum encourages more precise control by sampling continuous target positions spanning the entire court, and the policy is trained with an even smaller learning rate (1e⁻⁵) and Σ_{π} (0.025).

Additional Kinematic Constraints: In addition to wrist motion, other aspects of routine tennis motion may not always be reconstructed accurately from video data. Examples of inaccurate or otherwise undesirable reconstruction may include: (1) incorrect head orientation (e.g., the player may not be looking at the ball during a swing); (2) a misplaced free hand (e.g., the free hand is not on the racket during a two-handed swing). Similar to the joint correction for the wrist joint, example implementations are able to modify the high-level policy to output corrections for more joints, and design specific rewards using domain knowledge of tennis. For simplicity, example implementations may employ an alternative solution that first corrects the kinematic motion with heuristics informed by domain knowledge, and then the correction is adopted by the simulated character when imitating the kinematic motion with the low-level policy. Next is described the details of the kinematic corrections for addressing the head and free hand motion.

Head Motion for Tracking the Ball: In the real world, the player will rotate their head to closely track the tennis ball. However, the head/neck rotations may be poorly estimated by the kinematic pose estimator. To correct the head/neck motion, example implementations may first compute the offset angle between the head's facing direction and the direction from the head to the ball's current position, and add the offset angle back to the head/neck joints of the kinematic pose.

Free Hand Motion for Two-Hand Backhands: During a two-hand backhand swing, the player will hold the racket with both hands. However, the pose estimation results may not place the two hands close together due to occlusion and ambiguity, and the simulation may not be designed to provide force/torque to support the racket with the free hand. To improve the visual realism of the generated motions, example implementations adjust the kinematic pose to move the free hand close to the racket handle by solving inverse kinematics for the joints from the wrist to the shoulder along the arm of the free hand.

### Physics Modeling

This section introduces the physics modeling of objects (e.g., the tennis racket and the tennis ball) used in the physics simulation of example implementations.

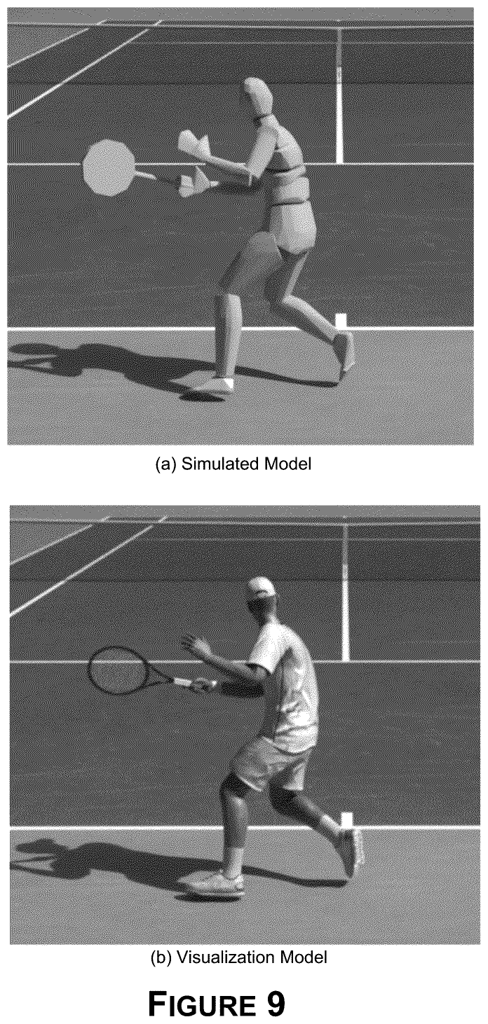

Tennis Racket and Grip: Since air resistance may not always be simulated in certain implementations, the tennis racket can be simplified as the combination of two solid cylinders with similar dimensions and masses as a real racket. The racket head is a rigid flat cylinder with a restitution of 0.9 and friction of 0.8 to simulate the effects of strings. Example implementations simplify the grip by directly attaching the end of the racket handle to the wrist joint and model different grips as different racket orientations relative to the palm (see FIG. 9).

Tennis Ball: In example implementations, the tennis ball is simulated as a rigid sphere with the same radius and mass as a real tennis ball, with a restitution of 0.9 and friction of 0.8. To simulate air friction and the effects of spin, example implementations add external air drag force F_{d} and Magnus force F_{M} into the simulation as follows:

F_{d}=C_{d}Av²/2. (5)

where v denotes the magnitude of the ball's velocity and A=πρR² is a constant determined by the air density ρ and the ball's radius R. F_{d} is always opposite to the direction of the ball's velocity, and C_{d} refers to the air drag coefficient, which is set to a constant of 0.55. In tennis, topspin (ball rotating forward) imparts downward acceleration to the ball leading it to drop quickly. Backspin (ball rotating backward) produces upward acceleration causing the ball to float. C_{L} refers to the lift coefficient due to Magnus force and is computed as 1/(2+v/vₛₚᵢₙ) where vₛₚᵢₙ denotes the magnitude of ball's spin velocity (the relative speed of the surface of the ball compared to its center point). F_{M} is always perpendicular to the direction of the ball's angular velocity (following right-hand rule) and points downwards for topspin and upwards for backspin.

### Example Implementations

In example implementations, simulated characters have successfully learned a variety of complex tennis skills while accomplishing the challenging task with high precision. The effectiveness of the physics correction for constructing a better motion embedding and the hybrid controller for successfully completing the task will now be discussed, along with evaluations of the system, including an analysis of statistics from a million simulated shots, extensive ablation studies on the contribution of each design choice, and finally the impact of the database size.

In Table 1, task performance of example controllers trained from sample videos of three players' motions is provided for illustrative purposes, showing the 25%, 50%, and 75% quantiles using the metrics collected from 10 k test sessions (15 consecutive balls per session). The trained controllers consistently achieve high performance in hit rates and bounce-in rates, as well as average bounce errors less than two meters.

TABLE 1
Task Performance

| | Hit rate | Bounce-in rate | Bounce error (m) |
|---|---|---|---|
| Player1-full | 0.85/0.92/1.00 | 0.77/0.85/0.92 | 1.49/1.74/1.93 |
| Player2-full | 0.92/0.92/1.00 | 0.73/0.81/0.85 | 1.16/1.37/1.68 |
| Player3-full | 0.92/0.92/1.00 | 0.69/0.77/0.85 | 1.31/1.56/1.89 |

Metrics for task performance: In example implementations, the player may be initialized at the center of the court baseline and tasked to hit a number of consecutive random incoming tennis balls (e.g., 15). The following statistics, for example, may then be collected to evaluate the model's task performance: hit rate, percentage of shots hit with the racket; bounce-in rate, percentage of shots returned that bounce inside the other side of the court; bounce position error, average distance between the target bounce position and a shot's bounce position if the ball lands inside the court.

Metrics for Motion Quality: The following metrics, for example, can be used to measure the physical plausibility of the generated motions: jitter, average of the third derivatives of all joint positions; and foot sliding, average displacement of body mesh vertices that contact the ground in two adjacent frames.

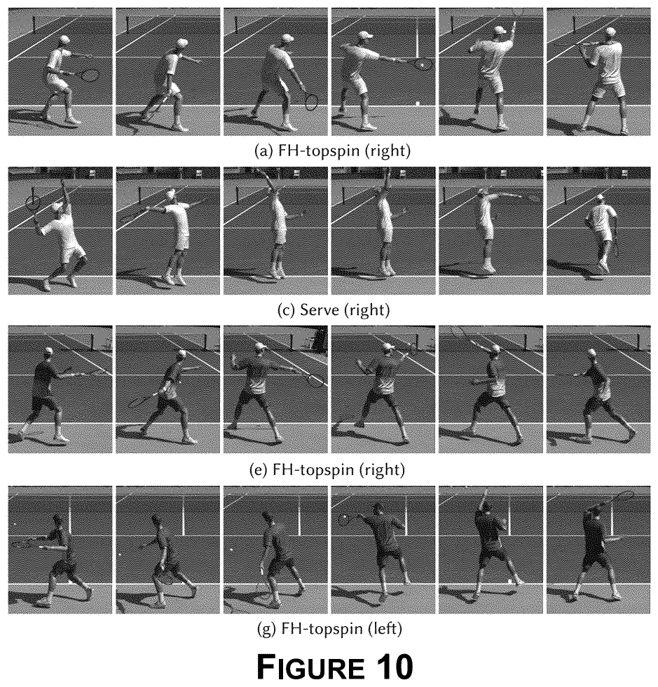

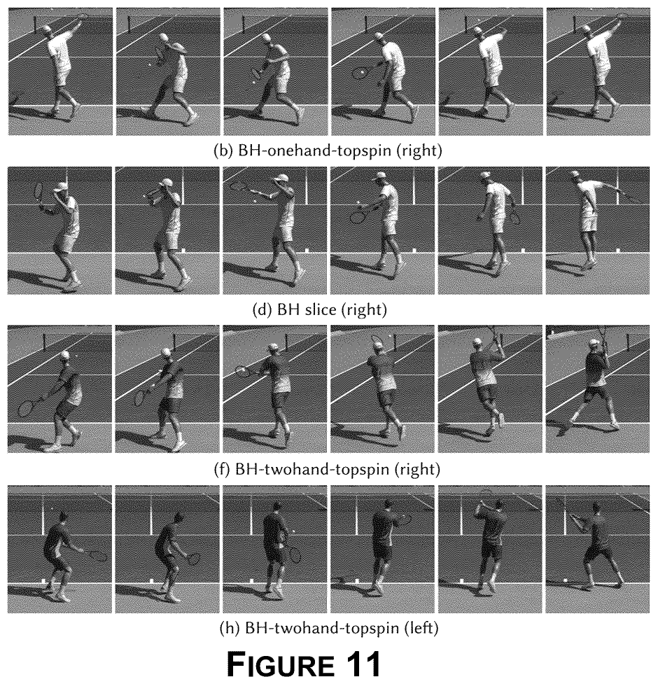

Training Complex Tennis Skills: First, example implementations demonstrate the diversity of skills that can be learned by the system. A single controller can be trained to perform various skills using the motion data of a captured (e.g., recorded) subject. FIGS. 10 and 11 illustrate examples of the diverse skills, including serves, forehand topspin shots, backhand topspin shots, and backhand slice shots generated by an example controller. The illustrated model is trained to utilize a versatile corpus of skills directly from video data, and effectively accomplishes the challenging task of controlling the character to hit an incoming tennis ball to a target location on the opposite side of the court. Users can specify, for example, a desired bounce position as well as the desired spin direction for the ball (e.g., topspin vs. backspin). Given the target spin direction, the controller can then perform the appropriate swing (e.g., topspin vs. slice), without the need for explicit annotations of the shot types in the source videos. For quantitative evaluation of the task performance, the example controller was tested for 10 k sessions (15 consecutive balls per session) and the statistics of the various metrics is reported in Table 1 (Player1-full). The illustrated controller is able to consistently hit consecutive incoming tennis balls with diverse incoming trajectories (median hit rate: 0.92, median bounce-in rate: 0.85). The illustrated controller is also able to return the ball close to the target location with both the median and mean bounce errors being less than two meters.

Different player styles: In various embodiments, training a controller to have skills from large-scale video data allows the controller to learn motion embeddings from different players' video clips, enabling controllers to adopt different playing styles. For example, certain implementations train controllers from video clips of multiple subjects having distinct playing styles. The example system is capable of training controllers using motion data from each player, where the learned skills capture their coarse styles and can be easily distinguished between the three players (e.g., FIGS. 10 and 11). The task performance for the other two controllers is reported in Table 1 (Player2-full and Player3-full), which also achieve strong performance with respect to all three metrics.

Table 2 provides ablations on the effect of physics correction (PhysicsCorr) and hybrid control (HybridCtr). Removing either of them leads to significant decreases in performance in these example implementations.

TABLE 2
Physics Correction

| | Hit rate | Bounce-in rate | Bounce error (m) |
|---|---|---|---|
| without PhysicsCorr | 0.85/0.92/0.92 | 0.69/0.77/0.85 | 2.00/2.37/2.81 |
| without HybridCtr | 0.69/0.85/0.92 | 0.31/0.46/0.54 | 2.82/3.43/4.00 |
| Player1-full | 0.85/0.92/1.00 | 0.77/0.85/0.92 | 1.49/1.74/1.93 |

Tennis rallies between two players: Although the example controller is trained under the single-player setting—that is, a single simulated character without an opponent—once trained, the controller can be directly applied to a two-player simulation in various embodiments. For example, example implementations can use two trained controllers of the same player or different players to drive two simulated characters to play tennis rallies against each other.

Tackling low-quality demonstrations: In various embodiments, the disclosed approach can also train a controller using low-quality demonstrations from videos. This can be illustrated through ablation studies that show the effectiveness of the disclosed approach.

Table 3 provides an evaluation of motion quality, comparing the motion output by the full system (Player1-full), the motion from the ablation (without PhysicsCorr), and motions at different stages of the system: estimated kinematic motion ( [symbol] ₖᵢₙ), physically corrected motion ( [symbol] _{corr}), and motion output by MVAE ( [symbol] ᵥₐₑ). Overall, the motion generated from the full system is more stable and physically plausible than one without PhysicsCorr and the motions at intermediate stages.

TABLE 3
Evaluation of Motion Quality

| | Jitter (10³ m/s³) | Foot sliding (cm) |
|---|---|---|
| [symbol] ₖᵢₙ | 6.08 | 7.41 |
| [symbol] _{corr} | 3.14 | 1.46 |
| [symbol] ᵥₐₑ | 0.96 | 4.70 |
| without PhysicsCorr | 1.19 | 2.82 |
| Player1-full | 0.51 | 1.46 |

Constructing motion embedding: Example implementations of the system can leverage two steps to process the noisy motions [symbol] ₖᵢₙ estimated by the kinematic pose estimator into smooth and plausible motions [symbol] ᵥₐₑ. First, the noisy motions estimated by the kinematic pose estimator ( [symbol] ₖᵢₙ) can be corrected by the low-level imitation policy using physics simulation. Second, the corrected motions ( [symbol] _{corr}) can be further denoised by training MVAE to embed the motion into a smooth motion space. Table 3 shows the motion quality of the motions at different stages. The physics-corrected motion [symbol] _{corr} exhibits less jittering and foot sliding, and the motions generated by the MVAE ( [symbol] ᵥₐₑ) are even more smooth. In the case that the smoothing by MVAE also increases foot sliding in [symbol] ᵥₐₑ, this can be mitigated by the low-level policy when imitating [symbol] ᵥₐₑ in physics simulation (Player1-full). To further evaluate the impact of the physics-based correction on the trained controllers, the MVAE can be trained using the original outputs of the pose estimator [symbol] ₖᵢₙ, and the resulting MVAE used to train the high-level policy (without PhysicsCorr). From Table 3, it is apparent that the illustrative controller trained without physics-based correction produces motion with more jittering and foot sliding compared to Player1-full. Table 2 also shows that the task performance of the controller trained without correction also decreases, which indicates the importance of using physics-based correction to construct a good motion embedding.

Hybrid control for wrist motion: To illustrate the effectiveness of the disclosed hybrid control for the wrist joint, example implementations can train the high-level policy to only predict the latent code for the MVAE and use the motion output from the MVAE without joint corrections as the target kinematic motion (without HybridCtr). As shown in Table 2, the agent is still able to achieve a reasonable hit rate, even if the bounce-in rate drops nearly by half and the bounce error increases significantly. This indicates that the proposed hybrid control can help with achieving the challenging task of returning the ball close to the target location.

### Supplementary Material

Low-level Imitation Policy Network: The policy is modeled by a neural network that maps a state s to a Gaussian distribution over actions π(a|s) with an input-dependent mean μ_{π}(s) and a fixed diagonal covariance matrix Σ_{π}. The mean is specified by a fully connected network with 3 hidden layers of [1024, 1024, 512] units, followed by linear output units. The value function V(s) is modeled by a similar network, but with a single linear output unit. All the hidden units use rectified linear unit (ReLU) activations.

Low-level Imitation Policy Rewards: The reward function is designed to encourage the policy to closely track the reference motion while also minimizing the energy expenditure. The reward consists of five terms:

r_{t=ω}_{₀}ᵣ_{ₜ}_{⁰}_{+ω}_{ᵥ}ᵣ_{ₜ}_{^{v}}_{+ω}_{ₚ}ᵣ_{ₜ}_{^{p}}_{+ω}_{ₖ}ᵣ_{ₜ}_{^{k}}_{+ω}_{ₑ}ᵣ_{ₜ}_{^{e}} (S1)

The joint rotation reward rₜ⁰. measures the difference between the local joint rotations qₜ^{j} and ground-truth \hat{q}ₜ^{j}.

rₜ^{o}=exp[−αₒΣⱼ₌₁^{J}(∥qₜ^{j}θ\hat{q}ₜ^{j}∥²)] (S2)

where J is the total number of joints, θ denotes the relative rotation between two rotations. The velocity reward rₜ^{v} measures the mismatch between local joint velocities \dot{q}ₜ^{j},; and ground-truth \hat{q}ₜ^{j}.

rₜ^{v}=exp[−αᵥΣⱼ₌₁^{J}(∥\dot{q}ₜ^{j}θ\hat{q}ₜ^{j}∥²)] (S3)

The joint position reward rₜ^{p}; encourages the 3D world joint positions Xₜ^{j} to match the ground truth \hat{x}ₜ^{j}.

rₜ^{p}=exp[−αₚΣⱼ₌₁^{J}(∥xₜ^{J}θ\hat{x}ₜ^{J}∥²)] (S4)

The keypoint reward rₜ^{k} encourages the projected 2D joint positions xₜ^{j} to match the ground-truth \hat{x}ₜ^{j}.

rₜ^{k}=exp[−αₖΣⱼ₌₁^{J}(∥xₜ^{j}−\hat{x}ₜ^{j}∥²)] (S5)

Finally, the reward rₜ^{e} denotes the power penalty computed as

rₜ^{e}=−[Σⱼ₌₁^{J}(∥\dot{q}ₜ^{j}·τₜ^{j}∥²)] (S6)
where τₜ^{j} is the internal torque applied on the joint j.

In the experiments, the weights and scales were manually specified as follows: ωₒ=0.6, ωᵥ, =0.1, ωₚ=0.2, ωₖ=0.1, ωₑ=0.01, αₒ=60, αᵥ=0.2, αₚ=100, αₖ=40.

Low-level Imitation Policy Training: Hyper-parameters used during training of the low-level policy is available in Table S1. The low-level policy is first trained using AMASS dataset with about 1 billion samples. Next, the low-level policy is fine-tuned using the kinematic motion dataset (Mₖᵢₙ) extracted from tennis videos with about 1 billion samples, which can then be used to correct the kinematic motions and create the physically corrected motion dataset M_{corr}. The low-level policy used in the control hierarchy for controlling the character's low-level movements is further fine-tuned using M_{corr}, for each different player with about 0.25 billion samples.

TABLE S1
Hyper-parameters for training the low-level policy

| Parameter | Value |
|---|---|
| Σ_{π}Action distribution variance | 0.03 |
| Samples per update iteration | 262144 |
| Policy/value function minibatch Size | 16384 |
| γ Discount | 0.99 |
| Adam stepsize | 0.00002 |
| GAE(λ) | 0.95 |
| TD(λ) | 0.95 |
| PPO clip threshold | 0.2 |
| Episode length | 300 |

Motion Embedding Network: In example implementations, the encoder is a three-layer feed-forward neural network, with 256 hidden units in each internal layer followed by exponential linear unit (ELU) activations. The output layer has two heads for μ and σ, required for the reparameterization trick used to train VAEs. The decoder uses mixture-of-expert (MoE) architecture. Specifically, the MoE decoder consists of six identically structured expert networks and a single gating network to blend the weights of each expert to define the decoder network to be used at the current time step. Similar to the encoder, the gating network is also a three-layer feed-forward neural network with 256 hidden units followed by ELU activations. The input to the gating network is the latent variable z and the current pose. Each expert network is also similar to the encoder network in structure. These compute the next pose from the latent variable z and the current pose.

Motion Embedding Training: Hyper-parameters used during training of the motion embedding model is available in Table S2. Example implementations adopt scheduled sampling, where a sample probability P is defined for each epoch. The predicted pose is used as the input for the next time step with probability 1−P, otherwise, the ground-truth pose is used. The entire training process is divided into three modes: supervised learning (P=1), scheduled sampling (decaying P), and autoregressive prediction (P=0). The number of epochs for each mode is 50, 50, and 400 respectively. For the scheduled sampling mode, the sampling probability decays to zero in a linear fashion with each learning iteration.

TABLE S2
Hyper-parameters for training the motion embedding model

| Parameter | Value |
|---|---|
| Latent space dimension | 32 |
| Number of frames for condition | 1 |
| Number of frames for prediction | 1 |
| Sequence length | 10 |
| Number of seqs per epoch | 50000 |
| Batch size | 100 |
| Learning rate | 0.0001 |

To train the model for predicting the motion phase with limited supervision (only 20% of the data is labeled with motion phase), example implementations adopt a curriculum similar to scheduled sampling. Example implementations define a sample probability q, which specifies the probability of sampling a motion sequence labeled with motion phase. The entire training process is also divided into two stages: q decays linearly from 1 to 0.1 in the first stage, and stays at q=0.1 for the second stage. Each stage is trained for 250 epochs.

High-Level Motion Planning Policy Network: Example embodiments may adopt the same network architecture as the low-level policy.

High-Level Motion Planning Policy Ball Trajectory Prediction Model: The ball trajectory prediction model is used for estimating future incoming ball trajectory as the observation for the high-level policy, as well as estimating the out-going ball bounce position for computing the ball position reward. At the offline stage, example embodiments compute a large ball trajectory pool by densely sampling the plausible ball states at launch time, including the height of the ball, the velocity of the ball and the spin velocity of the ball. The sample steps used in example embodiments are 0.1 m, 0.1 m/s and 0.5 RPS, respectively. To reduce complexity, all the trajectories are computed in the Y-Z plane. The computed trajectories are stored in a dense matrix used as a lookup table. At runtime, a particular trajectory can be estimated by indexing the lookup table with the ball's launch state, rounded by the sample steps used. In example embodiments, this ball trajectory prediction model provides efficient and accurate estimates of the future ball positions and bounce position.

High-Level Motion Planning Policy Training: Hyper-parameters used during training of the high-level policy (with the curriculum of three stages) is provided in Table S3.

TABLE S3
Hyper-parameters for training the high-level
policy with the curriculum of three stages.

| Parameter | Stage 1 | Stage 2 | Stage 3 |
|---|---|---|---|
| Σ_{π} Action | 0.25 | 0.04 | 0.0025 |
| distribution variance | | | |
| Samples per update | 327680 | 983040 | 983040 |
| iteration | | | |
| Policy/value function | 16384 | 16384 | 16384 |
| minibatch Size | | | |
| γ Discount | 0.99 | 0.99 | 0.99 |
| Adam stepsize | 0.0001 | 0.00002 | 0.00001 |
| GAE(λ) | 0.95 | 0.95 | 0.95 |
| TD(λ) | 0.95 | 0.95 | 0.95 |
| PPO clip threshold | 0.2 | 0.2 | 0.2 |
| Episode length | 600 | 300 | 300 |

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A processor comprising:
one or more circuits to:
employ an artificial agent to synthesize motion of a character in a simulation, the artificial agent having been generated by:
receiving video data comprising motion corresponding to at least one actor;
reconstructing one or more movements of the at least one actor in the received video data, the reconstructing comprising extracting a series of estimated kinematic poses for a set of frames in the video data; and
updating, using machine learning and based at least on the reconstructed movements, the artificial agent to control one or more motions of the character in the simulation.

2. The processor of claim 1, wherein the artificial agent comprises a generative machine learning model.

3. The processor of claim 1, wherein the video data comprises monocular broadcast video.

4. The processor of claim 1, wherein the artificial agent comprises an artificial agent generated without using motion capture data.

5. The processor of claim 1, wherein the reconstructing the movements further comprises applying one or more physics-based constraints to the series of estimated kinematic poses to correct for artifacts in the series of estimated kinematic poses.

6. The processor of claim 1, wherein the simulation corresponds to at least one of:
an interactive game; or
a simulated environment or scene that includes the simulated character.

7. The processor of claim 1, wherein the simulated character includes at least one of:
a participant of a sport;
a participant in a performance; or
a participant of an activity.

8. The processor of claim 1, wherein the video data comprises broadcasted events of at least one of: one or more sporting events, one or more performances, or one or more activities, wherein the at least one actor is at least one human participant of the at least one of: the one or more sporting events, the one or more performances, or the one or more activities, and wherein the simulated character is a virtual participant of the at least one of: the one or more sporting events, the one or more performances, or the one or more activities.

9. The processor of claim 1, wherein the video data comprises motion by the at least one actor interacting with at least one object, and the one or more circuits are further to employ the artificial agent to synthesize motion of one or more simulated objects with which the simulated character interacts.

10. The processor of claim 1, wherein the reconstructing the movements provides joint rotation data.

11. The processor of claim 1, wherein the processor is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system for generating synthetic data;
a system implemented using at least one language model;
a system incorporating one or more virtual machines (VMs);
a system implemented at least partially in a data center; or
a system implemented at least partially using cloud computing resources.

12. A processor comprising:
one or more circuits to:
generate an artificial agent to synthesize motion of a character in a simulation, by:
receiving video data comprising motion by at least one actor interacting with at least one object;
reconstructing one or more movements of the at least one actor in the video data, the reconstructing comprising extracting a series of estimated kinematic poses for a set of frames in the video data; and
updating, using machine learning and based at least on the reconstructed movements, the artificial agent to control one or more motions of the character in the simulation.

13. The processor of claim 12, wherein the artificial agent comprises a generative machine learning model.

14. The processor of claim 12, wherein the artificial agent comprises an artificial agent generated without using motion capture data.

15. The processor of claim 12, wherein the reconstructing the movements further comprises applying one or more physics-based constraints to the series of estimated kinematic poses to correct for artifacts in the series of estimated kinematic poses.

16. The processor of claim 12, wherein the video data comprises a broadcast of at least one of: one or more sporting events, one or more performances, or one or more activities, wherein the at least one actor is at least one human participant in the at least one of: the one or more sporting events, the one or more performances, or the one or more activities, and wherein the simulated character is a virtual participant in an interactive simulation of the at least one of: the one or more sporting events, the one or more performances, or the one or more activities.

17. The processor of claim 12, wherein the video data comprises motion by the at least one actor interacting with at least one object, and the artificial agent is generated further to synthesize motion of one or more simulated objects with which the simulated character interacts.

18. The processor of claim 12, wherein the reconstructing the movements provides joint rotation data.

19. The processor of claim 12, wherein the one or more circuits are to further use the artificial agent as a controller in an interactive game.

20. A system comprising:
one or more processing units to generate an artificial agent to synthesize motion of a character in a simulation, wherein the artificial agent uses video data comprising motion by at least one actor interacting with at least one object to reconstruct one or more movements of the at least one actor in the video data by extracting estimated kinematic poses for a set of frames in the video data, and wherein the artificial agent controls one or more motions of the character in the simulation using a machine learning model and based on the reconstructed one or more movements.
